(19) United States
(12) Patent Application Publication
(10) Pub. No.: US 2024/0193815 A1
(43) Pub. Date: Jun. 13, 2024

(54) VERIFICATION OF A MULTI-CAMERA CALIBRATION

(71) Applicant: GOOGLE LLC, Mountain View, CA (US)

(72) Inventor: Ali Osman Ulusoy, Seattle, WA (US)

(21) Appl. No.: 18/534,152

(22) Filed: Dec. 8, 2023

Related U.S. Application Data
(60) Provisional application No. 63/386,805, filed on Dec. 9, 2022.

(51) Int. Cl. G06T 7/80; H04N 23/90

(52) U.S. Cl. CPC G06T 7/80; H04N 23/90

(57) ABSTRACT

A method may receive first image data from a first camera and second image data from a second camera. A method may determine a calibration target position based on an extrinsic calibration, the first image data, the second image data, and calibration target information. A method may measure a first reprojection error of the first camera based on the extrinsic calibration, the calibration target position, and the first image data. A method may measure a second reprojection error of the second camera based on the extrinsic calibration, the calibration target position, and the second image data. Upon determining that any combination of the first reprojection error is greater than a threshold reprojection error or the second reprojection error is greater than the threshold reprojection error, the method may provide an indication that the first camera and the second camera are out of calibration.

### CROSS REFERENCE TO RELATED APPLICATION

This application claims the benefit and priority to U.S. Provisional Application No. 63/386,805, filed Dec. 9, 2022, the disclosure of which is incorporated herein by reference in its entirety.

### FIELD OF THE DISCLOSURE

The present disclosure relates to a system and method for determining if a multi-camera calibration is still within a tolerance.

### BACKGROUND

A telepresence conferencing system (i.e., telepresence system) can be used for audio/video communication between people. Some telepresence systems use a variety of techniques to enhance the realism of this communication in order to make a user feel like they are speaking in-person with another user. One technology used for this realism is the display. The display used in a telepresence system can be sized and positioned so that the user can view the person at an expected size (i.e., life-sized). Additionally, the display may be configured to display images that appear to be three-dimensional (3D). These 3D displays can require multiple images captured by a set of cameras configured to image a subject from multiple perspectives (i.e., multiple viewpoints).

### SUMMARY

The present disclosure describes methods to determine whether a calibration has fallen outside of a threshold level of accuracy needed to achieve a desired level of performance of the telepresence system. Performing an instrument calibration can be time intensive and obtrusive. Therefore, it is desirable not to perform the calibration more often than needed, while also maintaining the performance of the system. The present disclosure describes a method that may be used to determine when to execute a new camera calibration procedure by measuring a reprojection error using the present calibration. First, a calibration target is imaged with at least two cameras having an overlapping field of view, a calibration target pose is determined based on a present calibration and the image data, a reprojection error is determined for each of the cameras. If the reprojection error of any camera exceeds a threshold, it may be recommended that the device is re-calibrated.

In some aspects, the techniques described herein relate to a method including: receiving first image data from a first camera and second image data from a second camera, the first camera and the second camera having an overlapping field of view including a calibration target in a calibration target orientation; determining a calibration target position based on an extrinsic calibration, the first image data, the second image data, and calibration target information; measuring a first reprojection error of the first camera based on the extrinsic calibration, the calibration target position, and the first image data; measuring a second reprojection error of the second camera based on the extrinsic calibration, the calibration target position, and the second image data; and upon determining that any combination of the first reprojection error is greater than a threshold reprojection error or the second reprojection error is greater than the threshold reprojection error, providing an indication that the first camera and the second camera are out of calibration.

In some aspects, the techniques described herein relate to a device including: a first camera; a second camera; a processor in communication with the first camera and the second camera; and a memory coupled to the processor, the memory configured with instructions to: receive first image data from the first camera and second image data from the second camera, the first camera and the second camera having an overlapping field of view including a calibration target in a calibration target orientation, determine a calibration target position based on an extrinsic calibration, the first image data, the second image data, and calibration target information, measure a first reprojection error of the first camera based on the extrinsic calibration, the calibration target position, and the first image data, measure a second reprojection error of the second camera based on the extrinsic calibration, the calibration target position, and the second image data, and upon determining that any combination of: the first reprojection error is greater than a threshold reprojection error or the second reprojection error is greater than the threshold reprojection error, provide an indication that the first camera and the second camera are out of calibration.

In some aspects, the techniques described herein relate to a non-transitory computer readable memory that, when executed by a processor, causes a device connected to a first camera and a second camera to: receive first image data from the first camera and second image data from the second camera, the first camera and the second camera having an overlapping field of view including a calibration target in a calibration target orientation; determine a calibration target position based on an extrinsic calibration, the first image data, the second image data, and calibration target information; measure a first reprojection error of the first camera based on the extrinsic calibration, the calibration target position, and the first image data; measure a second reprojection error of the second camera based on the extrinsic calibration, the calibration target position, and the second image data; and upon determining that any combination of: the first reprojection error is greater than a threshold reprojection error or the second reprojection error is greater than the threshold reprojection error, provide an indication that the first camera and the second camera are out of calibration.

### BRIEF DESCRIPTION OF THE DRAWINGS

FIG. 1 illustrates a telepresence system according to an example of the disclosure.

FIG. 2 is a perspective view of a local user interacting with a telepresence system to communicate with a remote user, according to an example of the disclosure.

FIGS. 3A-3C illustrate relative cameras positions, according to an example of the disclosure.

FIG. 4 illustrates a target, according to an example of the disclosure.

FIG. 5 illustrates the layout of a viewing area, according to an example of the disclosure.

FIG. 6 is a flowchart of a method for verifying a calibration of two cameras of a telepresence system, according to an example of the disclosure.

### DETAILED DESCRIPTION

While traditional video conferencing through a computer (e.g., laptop) can provide an experience that is closer to a face-to-face meeting than a teleconference through a phone, it may have aspects that lack realism. For example, a user may see a small version of a person on their screen; the person on their screen may not appear to engage in eye-contact because their camera may be misaligned with their screen; and the person on their screen may have no apparent depth. To improve realism, systems have been created to present video of the person in three dimensions (3D) using virtual reality technology. A drawback with this approach however is that it can require the user to wear head-mounted displays, goggles, or 3D glasses, thereby negatively affecting the sense of realism.

Telepresence is a subset of videoconferencing, which provides an improved sense of realism to a user without requiring the user to necessarily wear any equipment. Instead, the user may simply sit in front of a display to observe a life-sized, high resolution, and three-dimensional (3D) video (i.e., images) of the person with whom they are communicating.

The display in a telepresence system may be configured to display 3D images based on a stereoscopic technique that does not require a user (i.e., viewer) to wear glasses (i.e., autostereoscopic). Instead, the display may project images spatially so that a user viewing the display may receive a first image of a stereoscopic pair at a left eye and a second image of the stereoscopic pair at the right eye. For example, the first image may be captured by a first camera pointed in a first direction at a scene and the second image may be captured by a second camera pointed in a second direction at the scene. The first direction and the second direction may provide the different perspectives necessary for the user to perceive the scene in 3D, and misalignments of either camera can negatively affect the 3D effect. While two cameras have been described for the purpose of explanation, an actual telepresence system may include more than two cameras (e.g., three, four, five, six, eight, etc.), which can make the alignment requirements even more precise.

In order to provide high quality 3D video reproduction in a telepresence system, it is necessary to maintain a highly accurate calibration between the relative positions of cameras in a camera array (i.e., set of cameras). The cameras may be calibrated in the factory and/or when the device is set up. For example, a change of less than a tenth of a degree may be enough to change a 3D image of the display. Mechanically maintaining this tolerance may be practically difficult. For example, temperature changes over a range of expected temperatures may alter the camera alignment enough to negatively affect the 3D experience. Further, a shock or continued stress to the telepresence system may alter the camera alignment enough to negatively affect the 3D experience. As a result, a calibration process may be used to determine the pose (i.e., 3 degree of freedom or 6 degree of freedom) of each camera instead of maintaining a precise (e.g., factory-set) alignment.

The calibration may include extrinsic and intrinsic parameters. The extrinsic parameters include the relative pose of each camera (i.e., rotation, translation and scale) with respect to each other and with respect to the display. The intrinsic parameters of each camera may include focal length, principal point, pixel skew, and distortion parameters.

Performing a calibration can be a time-intensive and somewhat obtrusive process that is often scheduled on a periodic basis. If the calibration is scheduled too frequently, then money and time may be wasted. If the calibration is scheduled too infrequently, however, then the 3D video reproduction will be lower quality than would otherwise be possible. The technical problem addressed by methods described herein is how to optimize determining when to perform a calibration.

The technical solution disclosed is to perform a calibration verification to determine when the camera relative alignment has drifted far enough from a prior extrinsic and/or intrinsic calibration to reduce the performance of the telepresence system outside a threshold reprojection error level. The calibration verification includes imaging a calibration target in a first calibration target orientation with at least two cameras, determining a calibration target position (for example a pose), determining reprojection errors for each camera based on the previous extrinsic calibrations and the calibration target position, and comparing a reprojection error for each camera to a threshold reprojection error. Further image data may be used generated with the calibration target in further orientations to provide even more robust combined reprojection error estimation.

While the example of a telepresence system is used throughout this disclosure, this is not intended to be limiting. The technical solutions described herein may be used to verify the calibrations of multiple cameras in other applications, for example in self-driving car applications, for virtual reality, augmented reality, or mixed reality headsets, and so forth.

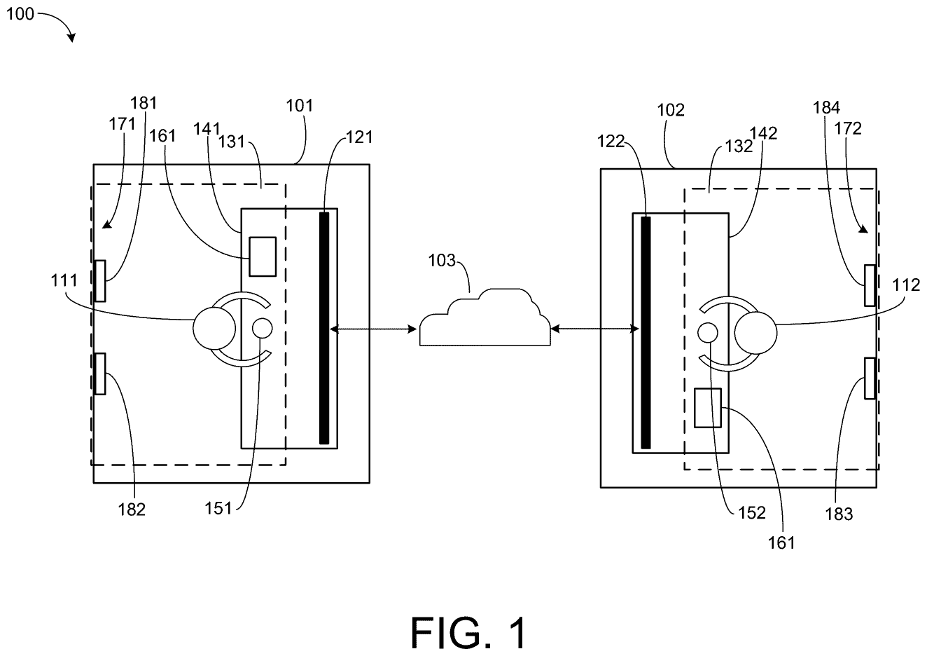

FIG. 1 illustrates a telepresence system 100 according to a possible implementation of the present disclosure. The telepresence system 100 may include a plurality of stations that can be communicatively coupled together via a network 103 (e.g., internet). The stations may be identified based on their relationship to a user. For example, a local user uses a local station to communicate with a remote user at a remote station. The terms local and remote are therefore relative and may be used interchangeably, depending on a frame of reference.

As mentioned, a local station 101 at a first location may be used by a local user 111 to communicate with a remote user 112 using a remote station 102 in a different area. The local user 111 may view images (i.e., 3D images) of the remote user 112 on a local display 121, while the remote user 112 may view images (i.e., 3D images) of the local user 111 on the remote display 122. For this the local station 101 may include a local set of cameras configured to capture images of a local viewing-area 131 and the remote station 102 may include a remote set of cameras configured to capture images of a remote viewing-area 132.

In a possible implementation, the local station 101 and the remote station 102 are each a room customized for telepresence communication. Accordingly, the rooms can include the equipment (e.g., accessories) for the user to use while communicating (i.e., while online). The room and equipment may be designed to have a prescribed layout so that the local station 101 and remote station 102 are identical versions of each other. For example, the rooms may have similar (e.g., the same) dimensions; similar (e.g., the same) looks (e.g., wall coverings, layout, etc.); and similar (e.g., the same) equipment (e.g., furniture, electronics, etc.). For example, the local station 101 and the remote station 102 may each have versions of the same desk for a user to sit at while the user communicates. Accordingly, the local user 111 sitting at a local desk 141 and the remote user 112 sitting at a remote desk 142 may occupy similar (e.g., the same) positions within their respective viewing area.

The stations may include accessories that are fixedly positioned within the room (e.g., within the viewing area). For example, the accessories can be at (respective) fixed locations in each viewing area. In a possible implementation, the accessories of the local station 101 may include a local microphone 151. The local microphone 151 may be fastened to a surface of the local desk 141. Likewise, the remote station 102 may include a remote microphone 152, which may be fastened to a surface of the remote desk 142.

In a possible implementation, the accessories of the local station 101 may further include a local equipment-mount 161 (e.g., tablet stand). The local equipment-mount may be fastened to a surface (e.g., top surface) of the local desk 141. Likewise, the remote station 102 may include a remote equipment-mount (e.g., tablet stand), which may be fastened to a surface of the remote desk 142.

Other accessories may be included and may be affixed or otherwise fastened to a surface in the viewing area. In a possible implementation, each station can include a speaker or speakers. As shown, the local station 101 may include a local (left) speaker 181 and a local (right) speaker 182, which can be fastened to a wall (or walls) of the local station 101. As shown the local (left) speaker 181 and the local (right) speaker 182 are mounted to a local wall 171 (i.e., back wall) behind the local user 111 in the local viewing-area 131. Likewise, the remote station 102 may include a remote (left) speaker 183 and a remote (right) speaker 182, which can be fastened to a wall (or walls) of the remote station 102. As shown, the remote (left) speaker 183 and the remote (right) speaker 184 are mounted to a remote wall 172 (i.e., back wall) behind the remote user 112 in the remote viewing-area 132.

The telepresence system 100 shown in FIG. 1 is one possible example. It should be understood that implementations in which the details shown are omitted or rearranged are still within the scope of the disclosure. Further some details (e.g., accessories, calibration targets) may be added, moved, rearranged, or removed from what is described while still being within the intended scope of the disclosure.

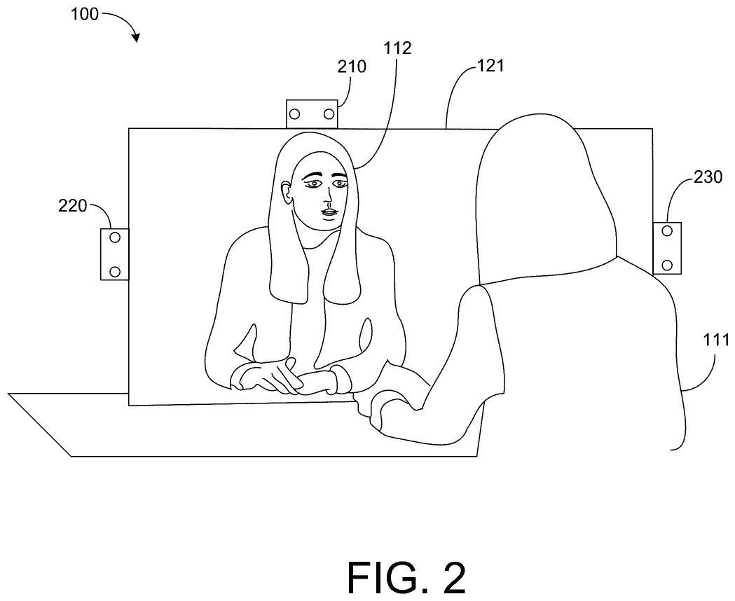

FIG. 2 is a perspective view of a local user interacting with a telepresence system to communicate with a remote user according to an implementation of the present disclosure. As shown, a local user 111 is facing a local display 121 to view an image of a remote user 112, which is rendered in 3D. This rendering may include combining images from a set of cameras position relative to each other to capture images of a viewing-area from multiple perspectives. As such, a set of cameras may be included at each station to capture images of a viewing area in which a user is positioned. The set of cameras may be integrated with the display. For example, cameras may be integrated in a frame that surrounds the display.

As shown in FIG. 2, the local display 121 can include a local set of cameras directed towards the local user 111, which includes a first subset 210 of cameras positioned in a top portion of the frame of the local display 121, a second subset 220 of cameras positioned in a left portion of the frame, and a third subset 230 of cameras is positioned in a right portion of the frame. For the example shown, each subset includes two cameras, but other camera configurations are possible and within the scope of the present invention.

Each camera may capture an image of the user in the viewing area from a different perspective (i.e., point-of-view, field-of-view). The different perspective images can be rendered into a 3D image based on the positions (i.e., alignments) of the cameras. The positions of the cameras may be relative. For example, in a three-camera system (i.e., cam1, cam2, cam3) the position may be described as (i) the position of cam2 relative to cam1, (ii) the position of cam 3 relative to cam1, (iii) the position of cam 1 relative to cam2, (iv) the position of cam3 relative to cam2, (v) the position of cam1 relative to cam3, and (vi) the position of cam2 relative to cam3.

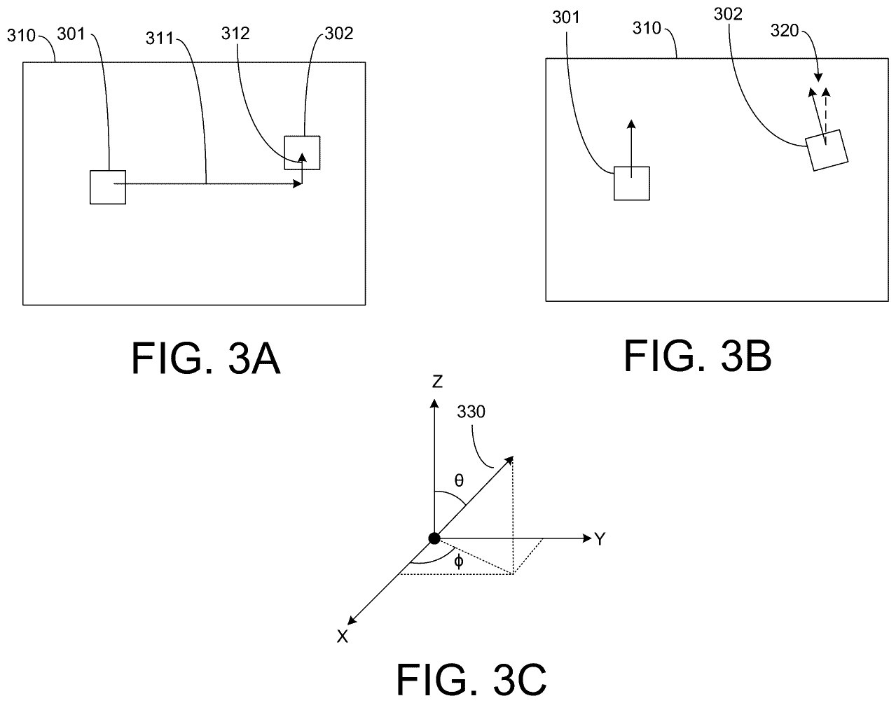

FIGS. 3A-3C illustrate relative cameras poses according to possible implementations of the present disclosure. A camera pose can include any or all of the relative positions shown in these figures. The cameras may be coplanar in a plane 310 defined by the display and each camera (of a pair of cameras) may have an optical axis that points outward from the plane 310. The camera orientation is defined by its optical axis direction and this direction does not have to be orthogonal to the display. The relative positions of the cameras may be defined in terms of the plane 310 and the optical axes. For example, the relative position may include relative locations of the cameras in the plane 310 as a horizontal offset 311 and a vertical offset 312 between a first camera 301 (i.e., reference camera) and a second camera 302, as shown in FIG. 3A. The relative position may further include a relative rotation 320 of the cameras about their respective optical axis in the plane 310, as shown in FIG. 3B. The relative position may further include an angular difference (q, f) between the optical axis 330 of a camera relative to a reference coordinate system (X, Y, Z) based on the optical axis of the first camera (X-axis) and the plane (YZ plane).

The relative positions of multiple cameras may be calculated based on relative positions of pairs of cameras. For example, in the three-camera system described above, the position of cam2 relative to cam1 (i.e., cam2→cam1) and the position of cam3 relative to cam2 (i.e., cam3→cam2) may be sufficient to compute the position of cam3 relative to cam1 (i.e., cam3→cam2→cam1). Accordingly, a target for calibrating the relative positions of the cameras may not be visible to all cameras of a system. For example, in the three-camera system described thus far, a first target visible to cam1 and cam2 may be used to determine the position of cam2 relative to cam1 and a second target visible to cam2 and cam3 may be used to determine the position of cam3 relative to cam 2. It may be unnecessary to include a third target visible to both cam3 and cam1 because this relative position may be computed, as described above.

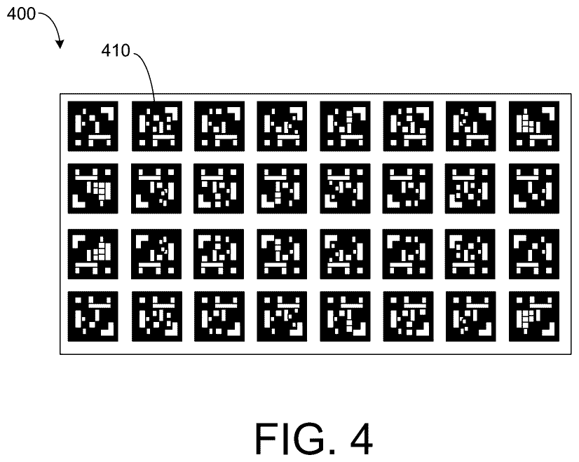

FIG. 4 illustrates a calibration target according to a first possible implementation of the present disclosure. The calibration target 400 may include patterns (i.e., fiducials). A pattern may include one or more features (i.e., fiducials). As shown in FIG. 4, a pattern 410 in the calibration target 400 may include a 2D set of white and black squares of equal size. In this example implementation, each square is a feature and the 2D set of features is a pattern 410, with the calibration target 400 including multiple patterns. In further examples, calibration target 400 may include any other type of fiducial marker operable for use in an optical calibration. The target can be mounted flat on a surface.

A calibration target may be implemented as physical markings on a surface, which may be flat or otherwise. In another possible implementation, the target may be implemented as a mirror configured to reflect patterns/features from a display to one or more of the cameras. For example, a camera at a local station 101 of the telepresence system 100 may receive a reflection of a target presented on the local display 121 via a mirror. When the mirror is curved, the curvature of the mirror may be known so that distortions added to the reflected target by the mirror may be removed as part of the calibration process.

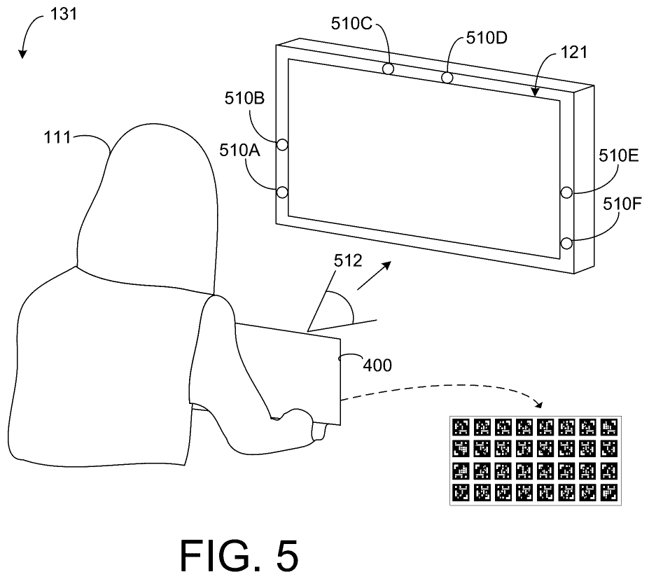

FIG. 5 illustrates the layout of a viewing-area during the execution of method 600, further described below. FIG. 5 includes an example telepresence system 100 with six cameras 510A, 510B, 510C, 510D, 510E, 510F. In examples, however, telepresence system 100 may include two or any greater number of cameras. The viewing area (e.g., local viewing-area 131) may be part of the overlapping field of view of any combination of the six cameras 510A, 510B, 510C, 510D, 510E, 510F.

Calibration target 400 may be placed within the fields of view of two or more of the cameras 510A, 510B, 510C, 510D, 510E, 510F. In FIG. 5, calibration target 400 is held by local user 111. In further examples, however, local user 111 may be positioned within the fields of views of the cameras using any convenient holding mechanism or fixture.

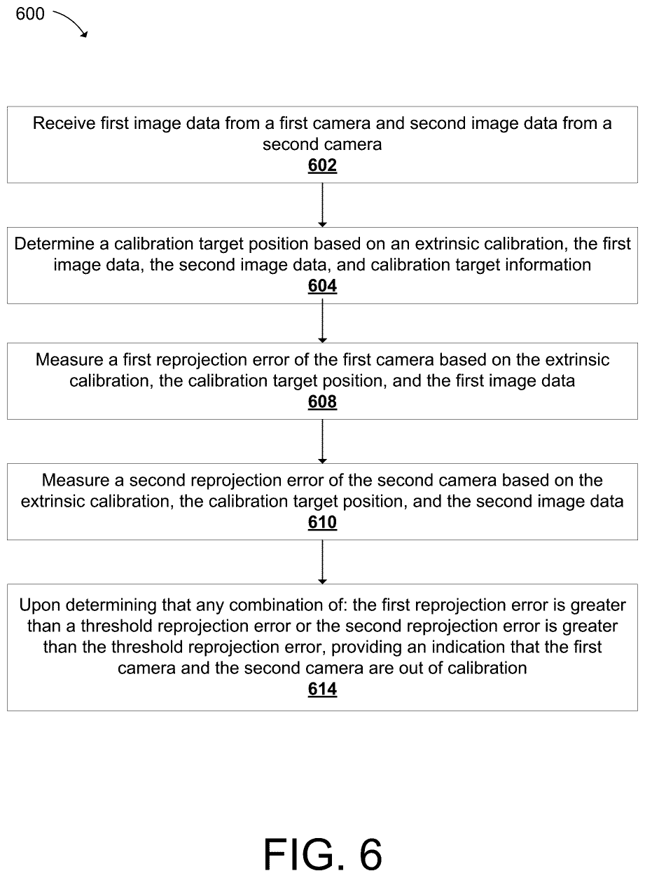

FIG. 6 is a flowchart of a method 600 for verifying a calibration of two cameras of a telepresence system, according to an example of the disclosure. Method 600 may be executed by a processor in communication with a memory within telepresence system 100, in a computing device in communication with telepresence system 100, or in a server.

The method 600 may be performed periodically, on-demand, or as triggered by an event. For example, the method 600 may be performed periodically. In further examples, the method 600 may be performed when prompted by a user or when a camera temperature is determined to be over a threshold temperature. Other triggers for the method 600 are also possible.

The method 600 beings with step 602. In step 602, first image data from a first camera and second image data from a second camera are received. For example, data may be received from first camera 510A and second camera 510B. Step 602 is not intended to be limiting, however. In examples, the step 602 may further include receiving image data from any additional number of cameras.

The first camera and the second camera have an overlapping field of view operable to capture a calibration target in a calibration target orientation within that field of view. In examples, the calibration target may comprise the calibration target 400 including a plurality of fiducials described above. In further examples, however, the calibration target may comprise a natural image with a subset of features that are distinctive enough to be matched reliably between image data from multiple cameras. Natural features in the scene, which could include the static things in the room, like the microphone or the furniture, or dynamic things like people using the telepresence system 100, may serve as a replacement for the planar fiducials in the calibration target 400.

The calibration target orientation may be any pose, position, orientation of the calibration target 400 that may allow it to be at least partially viewed by both the first camera 510A and the second camera 510B.

In examples, the first image data and the second image data may be captured substantially simultaneously. In examples, the first image data and the second image data may be captured while the calibration target 400 is in substantially the same calibration target orientation.

The first image data and the second image data may comprise any known type of image data, i.e., JPEG.

The method 600 may continue with step 604. In step 604, a calibration target position may be determined based on an extrinsic calibration, the first image data, the second image data, and calibration target information. The calibration target information may include information about one or more predetermined features of the calibration target 400. In examples, the calibration target information may comprise information about identification of fiducials, spacing between fiducials, relative positions of one or more fiducials, and so forth. The calibration target information may allow for the deduction of information about the pose of the calibration target 400 with respect to a camera based on fiducials in the calibration target 400 imaged by a camera.

A calibration target position 512 is depicted in FIG. 5. In examples, the calibration target position 512 may be a pose or a 3D model of the calibration target 400. In the circumstance where the calibration target 400 is a 2D chart, for example, the calibration target position 512 may align with the normal of a printed surface of the chart including any fiducials.

Step 604 uses the extrinsic calibration of the first camera 510A and the second camera 510B most recent calibration information capturing the relative camera alignments. In the examples where there are more than two cameras, the extrinsic calibration may include relative alignment and/or pose information about the additional camera(s) as well.

The calibration information may further include one or more camera intrinsics, for example focal length, a principal point, a pixel skew, or distortion parameters. In examples, the camera intrinsics may be further used to determine the calibration target position 512.

In examples, determining the calibration target position 512 may further comprise identifying a first fiducial and a second fiducial in the calibration target 400. Knowing the precise layout of first and second fiducials within the calibration target 400 may further help determine the pose/orientation of the calibration target 400.

In examples, determining the calibration target position 512 may further comprise determining a first calibration target region pose and a second calibration target region pose, the first calibration target region pose being different from the second calibration target region pose. In examples, the calibration target 400 may not be completely planar. For example, as may be seen in FIG. 5, the calibration target 400 may not be completely planar in the area where the local user 111 is holding it if the user is gripping the calibration target 400 tightly. In such examples, it may be helpful to identify the poses of different calibration target regions of the calibration target 400 to account for deformation in the calibration target 400 when performing the calibration verification.

In examples, additional variables that represent the off-plane deformation of the calibration target 400 fiducials may be included in order to solve for non-rigid deformation of the calibration target 400. This may allow for the solving of the 6DOF pose of the calibration target 400 along with the calibration target 400 deformations simultaneously.

In examples, determining a calibration target position 512 may include determining a first fiducial 3D position and a second fiducial 3D position based on the extrinsic calibration, the first image and the second image. The first fiducial 3D position and the second fiducial 3D position may correspond to any two fiducials found within the calibration target 400. In examples, it may be possible to determine every fiducial identifiable in the calibration target 400 by each or both of the first camera 510A and the second camera 510B. By determining a 3D position for individual fiducials within the calibration target 400, it may be possible to account for the deformation of calibration chart described above when performing the calibration verification.

The method 600 may continue with step 608. In the step 608, a first reprojection error may be measured for the first camera based on the extrinsic calibration, the calibration target position, and the first image data. A reprojection error measures the image distance between the reprojection of a 3D model estimation of a fiducial and its corresponding true projection in 2D in the camera image. The 3D model estimation is based on the extrinsic calibration, and the true projections are the observed feature points of the calibration target 400 in the first image data. Reprojection error is typically measured in pixels on the image plane.

In examples, the reprojection error of all fiducials visible in an image are measured to determine a camera-specific reprojection error for a particular calibration target orientation. Reprojection error statistics may be tracked over the fiducials for a camera in order to identify systematic errors related to the camera. If any camera includes a reprojection error that exceeds the threshold reprojection error, re-calibration is recommended.

The method 600 may continue with step 610. In step 610, a second reprojection error may be determined of the second camera based on the extrinsic calibration, the calibration target position, and the second image data. Step 610 is similar to step 608 described above.

The method 600 may continue with step 614. In step 614, upon determining that the any combination of the first reprojection error is greater than a threshold reprojection error or the second reprojection error is greater than the threshold reprojection error, an indication may be provided that the first camera and the second camera are out of calibration. In examples, the threshold reprojection error may be one pixel. In examples, the threshold reprojection may be half a pixel.

The indication may comprise a message prompting the user to schedule and/or perform a full calibration. The indication may comprise an electronic message to a supplier or service provider to calibrate the telepresence system 100. In examples, the indication may share the reprojection error value with the user. In examples, the indication may direct the user to perform one or more corrective actions.

Although two camera are described with regards to the method 600, it will be understood that the method may be executed with any additional number of cameras. Each additional camera included will mean receiving an additional respective image data at step 602, adding a step to calculate a reprojection error similar to steps 608 and 610, and combining the additional reprojection error at step 612.

In examples, steps 602-610 may be repeated for additional calibration target orientations. For example, the local user 111 may hold the calibration target 400 in 4 additional orientations to obtain image data to verify a calibration, for a total of 5 calibration target orientations. The additional reprojection errors calculated for each fiducial at each camera may be aggregated across all chart orientations to create a more accurate reprojection error measurement. This may allow for a more accurate determination of how close in alignment the cameras are to the most recent extrinsic calibration values.

Reprojection errors for each respective fiducial may be aggregated across all chart orientations per camera, and statistics (mean, median maximum, etc.) may be generated across all fiducials for each camera. In examples, a median reprojection error may be determined per camera to compare to the threshold reprojection error.

A full calibration may require imaging the calibration target 400 in as many as 50 calibration target orientations, a procedure that can take as long as a half hour to complete. Method 600 may provide a quicker (i.e., only a few minutes) way for a user to verify that a camera alignment is still within a threshold reprojection error of a previous extrinsic calibration. Verifying the calibration using the method described herein may save a user from the trouble of calibrating more frequently than is necessary to maintain performance. Likewise, the quick calibration verification method described herein may flag for the user precisely the moment when a full calibration is indicated so that performance is also maintained.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for the purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

In some aspects, the techniques described herein relate to a method, wherein determining the calibration target position further includes identifying a first fiducial and a second fiducial in the calibration target.

In some aspects, the techniques described herein relate to a method, further including: determining a first fiducial 3D position and a second fiducial 3D position based on the extrinsic calibration, the first image data and the second image data.

In some aspects, the techniques described herein relate to a method, wherein determining the calibration target position further includes determining a first calibration target region pose and a second calibration target region pose, the first calibration target region pose being different from the second calibration target region pose.

In some aspects, the techniques described herein relate to a method, wherein the calibration target position is further determined based on a camera intrinsic including at least one of: a focal length, a principal point, a pixel skew, or distortion parameters.

In some aspects, the techniques described herein relate to a method, wherein the calibration target orientation is a first calibration target orientation, the calibration target position is a first calibration target position, and the method further includes: receiving third image data from the first camera and fourth image data from the second camera, the first camera and the second camera having the calibration target in the overlapping field of view in a second calibration target orientation; and determining a second calibration target position based on the extrinsic calibration, the third image data, and the fourth image data, wherein measuring the first reprojection error of the first camera is further based on the extrinsic calibration, the second calibration target position, and the third image data, and measuring the second reprojection error of the second camera is further based on the extrinsic calibration, the second calibration target position, and the fourth image data.

In some aspects, the techniques described herein relate to a method, wherein the threshold reprojection error is one pixel.

In some aspects, the techniques described herein relate to a device, wherein determining the calibration target position further includes identifying a first fiducial and a second fiducial in the calibration target.

In some aspects, the techniques described herein relate to a device, wherein the memory is further configured with instructions to: determine a first fiducial 3D position and a second fiducial 3D position based on the extrinsic calibration, the first image data and the second image data.

In some aspects, the techniques described herein relate to a device, wherein determining the calibration target position further includes determining a first calibration target region pose and a second calibration target region pose, the first calibration target region pose being different from the second calibration target region pose.

In some aspects, the techniques described herein relate to a device, wherein the calibration target position is further determined based on a camera intrinsic including at least one of: a focal length, a principal point, a pixel skew, or distortion parameters.

In some aspects, the techniques described herein relate to a device, wherein the calibration target orientation is a first calibration target orientation, the calibration target position is a first calibration target position, and the memory is further configured with instructions to: receive third image data from the first camera and fourth image data from the second camera, the first camera and the second camera having the calibration target in the overlapping field of view in a second calibration target orientation; and determine a second calibration target position based on the extrinsic calibration, the third image data, and the fourth image data, wherein measuring the first reprojection error of the first camera is further based on the extrinsic calibration, the second calibration target position, and the third image data, and measuring the second reprojection error of the second camera is further based on the extrinsic calibration, the second calibration target position, and the fourth image data.

In some aspects, the techniques described herein relate to a device, wherein the threshold reprojection error is one pixel.

In some aspects, the techniques described herein relate to a non-transitory computer readable memory wherein determining the calibration target position further includes identifying a first fiducial and a second fiducial in the calibration target.

In some aspects, the techniques described herein relate to a non-transitory computer readable memory, wherein the non-transitory computer readable memory further causes the device to: determine a first fiducial 3D position and a second fiducial 3D position based on the extrinsic calibration, the first image data and the second image data.

In some aspects, the techniques described herein relate to a non-transitory computer readable memory, wherein determining the calibration target position further includes determining a first calibration target region pose and a second calibration target region pose, the first calibration target region pose being different from the second calibration target region pose.

In some aspects, the techniques described herein relate to a non-transitory computer readable memory, wherein the calibration target position is further determined based on a camera intrinsic including at least one of: a focal length, a principal point, a pixel skew, or distortion parameters.

In some aspects, the techniques described herein relate to a non-transitory computer readable memory, wherein the calibration target orientation is a first calibration target orientation, the calibration target position is a first calibration target position, and the non-transitory computer readable memory further causes the device to: receive third image data from the first camera and fourth image data from the second camera, the first camera and the second camera having the calibration target in the overlapping field of view in a second calibration target orientation; and determine a second calibration target position based on the extrinsic calibration, the third image data, and the fourth image data, wherein measuring the first reprojection error of the first camera is further based on the extrinsic calibration, the second calibration target position, and the third image data, and measuring the second reprojection error of the second camera is further based on the extrinsic calibration, the second calibration target position, and the fourth image data.

What is claimed is:

1. A method comprising:
receiving first image data from a first camera and second image data from a second camera, the first camera and the second camera having an overlapping field of view including a calibration target in a calibration target orientation;
determining a calibration target position based on an extrinsic calibration, the first image data, the second image data, and calibration target information;
measuring a first reprojection error of the first camera based on the extrinsic calibration, the calibration target position, and the first image data;
measuring a second reprojection error of the second camera based on the extrinsic calibration, the calibration target position, and the second image data; and
upon determining that any combination of the first reprojection error is greater than a threshold reprojection error or the second reprojection error is greater than the threshold reprojection error, providing an indication that the first camera and the second camera are out of calibration.

2. The method of claim 1, wherein determining the calibration target position further comprises identifying a first fiducial and a second fiducial in the calibration target.

3. The method of claim 2, further comprising:
determining a first fiducial 3D position and a second fiducial 3D position based on the extrinsic calibration, the first image data and the second image data.

4. The method of claim 1, wherein determining the calibration target position further comprises determining a first calibration target region pose and a second calibration target region pose, the first calibration target region pose being different from the second calibration target region pose.

5. The method of claim 1, wherein the calibration target position is further determined based on a camera intrinsic comprising at least one of: a focal length, a principal point, a pixel skew, or distortion parameters.

6. The method of claim 1, wherein the calibration target orientation is a first calibration target orientation, the calibration target position is a first calibration target position, and the method further comprises:
receiving third image data from the first camera and fourth image data from the second camera, the first camera and the second camera having the calibration target in the overlapping field of view in a second calibration target orientation; and
determining a second calibration target position based on the extrinsic calibration, the third image data, and the fourth image data, wherein measuring the first reprojection error of the first camera is further based on the extrinsic calibration, the second calibration target position, and the third image data, and measuring the second reprojection error of the second camera is further based on the extrinsic calibration, the second calibration target position, and the fourth image data.

7. The method of claim 1, wherein the threshold reprojection error is one pixel.

8. A device comprising:
a first camera;
a second camera;
a processor in communication with the first camera and the second camera; and
a memory coupled to the processor, the memory configured with instructions to:
receive first image data from the first camera and second image data from the second camera, the first camera and the second camera having an overlapping field of view including a calibration target in a calibration target orientation,
determine a calibration target position based on an extrinsic calibration, the first image data, the second image data, and calibration target information,
measure a first reprojection error of the first camera based on the extrinsic calibration, the calibration target position, and the first image data,
measure a second reprojection error of the second camera based on the extrinsic calibration, the calibration target position, and the second image data, and
upon determining that any combination of: the first reprojection error is greater than a threshold reprojection error or the second reprojection error is greater than the threshold reprojection error, provide an indication that the first camera and the second camera are out of calibration.

9. The device of claim 8, wherein determining the calibration target position further comprises identifying a first fiducial and a second fiducial in the calibration target.

10. The device of claim 9, wherein the memory is further configured with instructions to:
determine a first fiducial 3D position and a second fiducial 3D position based on the extrinsic calibration, the first image data and the second image data.

11. The device of claim 8, wherein determining the calibration target position further comprises determining a first calibration target region pose and a second calibration target region pose, the first calibration target region pose being different from the second calibration target region pose.

12. The device of claim 8, wherein the calibration target position is further determined based on a camera intrinsic comprising at least one of: a focal length, a principal point, a pixel skew, or distortion parameters.

13. The device of claim 8, wherein the calibration target orientation is a first calibration target orientation, the calibration target position is a first calibration target position, and the memory is further configured with instructions to:
receive third image data from the first camera and fourth image data from the second camera, the first camera and the second camera having the calibration target in the overlapping field of view in a second calibration target orientation; and
determine a second calibration target position based on the extrinsic calibration, the third image data, and the fourth image data, wherein measuring the first reprojection error of the first camera is further based on the extrinsic calibration, the second calibration target position, and the third image data, and measuring the second reprojection error of the second camera is further based on the extrinsic calibration, the second calibration target position, and the fourth image data.

14. The device of claim 8, wherein the threshold reprojection error is one pixel.

15. A non-transitory computer readable memory that, when executed by a processor, causes a device connected to a first camera and a second camera to:
receive first image data from the first camera and second image data from the second camera, the first camera and the second camera having an overlapping field of view including a calibration target in a calibration target orientation;
determine a calibration target position based on an extrinsic calibration, the first image data, the second image data, and calibration target information;
measure a first reprojection error of the first camera based on the extrinsic calibration, the calibration target position, and the first image data;
measure a second reprojection error of the second camera based on the extrinsic calibration, the calibration target position, and the second image data; and
upon determining that any combination of: the first reprojection error is greater than a threshold reprojection error or the second reprojection error is greater than the threshold reprojection error, provide an indication that the first camera and the second camera are out of calibration.

16. The non-transitory computer readable memory of claim 15 wherein determining the calibration target position further comprises identifying a first fiducial and a second fiducial in the calibration target.

17. The non-transitory computer readable memory of claim 16, wherein the non-transitory computer readable memory further causes the device to:
determine a first fiducial 3D position and a second fiducial 3D position based on the extrinsic calibration, the first image data and the second image data.

18. The non-transitory computer readable memory of claim 15, wherein determining the calibration target position further comprises determining a first calibration target region pose and a second calibration target region pose, the first calibration target region pose being different from the second calibration target region pose.

19. The non-transitory computer readable memory of claim 15, wherein the calibration target position is further determined based on a camera intrinsic comprising at least one of: a focal length, a principal point, a pixel skew, or distortion parameters.

20. The non-transitory computer readable memory of claim 15, wherein the calibration target orientation is a first calibration target orientation, the calibration target position is a first calibration target position, and the non-transitory computer readable memory further causes the device to:
receive third image data from the first camera and fourth image data from the second camera, the first camera and the second camera having the calibration target in the overlapping field of view in a second calibration target orientation; and
determine a second calibration target position based on the extrinsic calibration, the third image data, and the fourth image data, wherein measuring the first reprojection error of the first camera is further based on the extrinsic calibration, the second calibration target position, and the third image data, and measuring the second reprojection error of the second camera is further based on the extrinsic calibration, the second calibration target position, and the fourth image data.
